(19) United States
(12) Patent Application Publication
(10) Pub. No.: US 2014/0283470 A1
(43) Pub. Date: Sep. 25, 2014

(54) PREFABRICATED WALLS FOR TEMPORARY HOUSING APPLICATIONS

(71) Applicant: Jayco Industries, Apple Valley, CA (US)

(72) Inventors: Fredrick A. Kuhn, Rancho Cucamonga, CA (US); John T. Jeffs, Apple Valley, CA (US); Charles Dean Bledsoe, Oak Hills, CA (US)

(73) Assignee: Jayco Industries, Apple Valley, CA (US)

(21) Appl. No.: 14/187,959

(22) Filed: Feb. 24, 2014

Related U.S. Application Data
(60) Provisional application No. 61/768,270, filed on Feb. 22, 2013.

(51) Int. Cl. H02G 3/22; E04C 2/52; E04H 1/00

(52) U.S. Cl. CPC H02G 3/22; E04H 1/005; E04C 2/521
USPC 52/220.2; 52/745.1

(57) ABSTRACT

An assembly of prefabricated wall and junction units that can be assembled to provide utilities such as water, power, communications and sewer to a plurality of different living spaces. The prefabricated units are uniform and can be assembled together in a rapid fashion to facilitate building of a temporary or permanent living space.

### BACKGROUND OF THE INVENTION

1. Field of the Invention

The present invention relates to temporary or semi-permanent housing applications and, in particular concerns modular structures that can be assembled to form walls for housing applications such as trailer parks and the like.

2. Description of the Related Art

Events can occur that give rise to a sudden need for temporary housing. Such events include natural disasters or sudden economic events. For example, many displaced people after the hurricane Katrina lost their houses and trailer parks with pre-fabricated trailers were used to house these people on a temporary basis. As another example, the current oil boom in North Dakota has placed significant strain on the local housing with the influx of people needed to work in the suddenly expanded oil business. This has also led to the use of trailers for temporary or semi-permanent housing.

Thus, these types of events give rise to a demand for temporary housing sites. Often, these housing sites comprise trailer parks where trailers are located. Each trailer preferably has to be supplied with water, power and sewage hookups. In more permanently established trailer parks, these services are often provided via underground trenches and there is a utility hook up for each trailer site. However, digging such trenches and establishing the utility hook up for each site is time consuming and costly which limits the ability to deploy housing quickly to meet sudden demand.

Hence, there is a need for a system and method that is adapted to permit the rapid construction of trailer sites or other temporary or more permanent housing or work locations. To this end, there is a need for a system and method of defining such sites and providing the sites with the essential utilities which can include power, water, data, sewage etc.

### SUMMARY OF THE INVENTION

To address the foregoing needs, the present invention comprises a system of preassembled elongate units that can be pre-equipped with utility conduits such as piping for water and/or sewage, electrical and data service in some implementations. Each of the preassembled units are configured to be attached either to other units, to form a long wall, with the piping and wiring being interconnected to each other. In one exemplary embodiment, the system can also include junction units that allow for elongate units to extend in different directions.

In one specific implementation, a plurality of elongate units can be connected together with junction boxes interposed between units. Elongate units can then be attached to the junction boxes to extend in perpendicularly outward from the previously assembled elongate units. The elongate units are, in one example, sized so as to define with width of a housing or work site. The perpendicular elongate units can then form side walls of the housing or work site. Since each elongate unit has piping for water and/or sewage and electrical conduit or wiring, each one of the perpendicularly extending elongate units can form a hook up unit for a housing or work site. The terminal end of an elongate unit that forms a side wall of a trailer site can have the end wall capped to seal the elongate unit.

The utility connection within the elongate units can also then be attached to permanent, semi-permanent or temporary water supplies, sewage or septic systems and electrical power systems. Thus, a housing or work location that can be a trailer park, mobile home park, collection of container buildings etc. or some combination thereof, of an infinite different configurations can be quickly assembled from modular components above ground.

In one specific implementation, the elongate units are formed of a metal box having dimensions of approximately 24″ wide, 24″ tall and 154″ long although these dimensions can vary depending upon the application. The elongate units can be open on the top to permit access to the piping and wiring. A cover member can also be installed to seal the elongate units. The cover member may, in some implementations define an electrical raceway where wiring can either be preinstalled or installed during assembly. The elongate units may also include forklift hoist locations to permit easy mounting of the elongate units onto trucks for transport. The elongate units may also have mounting feet that provide stability for the elongate units. The units themselves may also have insulation within the interior space so as to prevent or inhibit the water and/or sewage pipes from freezing.

In some specific implementations, the elongate units may be access panels to facilitate interconnecting members. The ends of the elongate units may have flat surfaces that can abut flat surfaces of the adjacent panel such that the flat surfaces can be bolted or screwed together. Alternatively, joint units can be used to facilitate interconnection of the various units. Alternatively, interconnection members such as U-shaped interconnection members can be secured to the adjacent ends of adjacent elongate units to secure the units together. Other types of straps and the like can also be used without departing from the scope of the present invention. The elongate units and the joint units can be formed of metal or formed of other construction materials that permit the units to be at least partially pre-assembled prior to delivery to the construction site.

In one implementation, the joint unit may comprise a four sided, generally square unit with four openings that can either be capped as needed or attached to an elongate unit to define side walls and the like. Each of the sides will preferably have an opening sized to match the opening in the elongate units and can, in some implementations, have piping and wiring so as to permit interconnection therethrough of the water and/or sewage and electrical power lines. The joint unit may also include a cover, insulation, and cable raceway trays etc. that also match the elongate units. In one specific implementation, the joint units are 24″ by 24″ wide and tall on all four sides but the dimensions can vary based upon implementation.

The system disclosed herein greatly simplifies the construction of a temporary or semi-permanent or even a permanent housing or work site. Elongate units that have been pre-assembled with piping and wiring and joint units can be shipped in an easily stacked fashion to a job site. The job site can then be leveled using earth moving equipment. The elongate units and joint units can then be assembled together and the piping and wiring interconnected. The cover members can then be positioned onto the elongate units and joint units once the piping and wiring is assembled.

Thus, the system and method can permit the rapid construction of a series of space sites each of which has a defined border and each of which can be supplied with utilities and all of this can be accomplished without digging trenches, laying cables or pipe. Consequently, the system can be assembled in a very rapid fashion once the components have been delivered to a worksite and the worksite has been leveled sufficiently. This allows for the rapid construction of temporary housing or work sites which, in events like natural disasters with significant numbers of displaced people, can allow for the rapid accommodation of those people displaced from their homes and living accommodations into new living accommodations. Similarly, large numbers of temporary work building can also be accommodated in an expedited fashion. These and other objects and advantages of the present invention will become more apparent from the following description taken in conjunction with the accompanying drawings.

### BRIEF DESCRIPTION OF THE DRAWINGS

FIG. 1 is a top view of a living location and system that defines a plurality of temporary living and/or work spaces using the walls and junction units of one embodiment of the present invention;

FIGS. 2A-2E are perspective, exploded perspective, cross-sectional end, bottom and side views of the wall units of an embodiment of FIG. 1;

FIGS. 2F and 2G are detail views illustrating an interconnecting system of the wall units of FIGS. 2A-2E;

FIGS. 3A and 3B are exploded perspective and end side views of the junction units of the embodiment of FIG. 1;

FIG. 3C is an exploded perspective view illustrating the interconnection between the wall units and the junction units;

FIGS. 4A-4C are top, perspective and exploded perspective views that illustrates the interconnection between a junction unit and a wall unit of the system of FIG. 1;

FIGS. 5A-5E are cross-sectional side, detailed side, front, side views and top views of another embodiment of wall units and junction units of another embodiment of the present invention;

FIG. 6 is a cross-sectional side view that illustrates one embodiment of a wall unit and junction unit and the components contained therein;

FIG. 7 is a side view of a wall unit illustrating one embodiment of an interconnection or interface unit that can be used with the embodiment of FIG. 1; and

FIG. 8 is a schematic illustration of another embodiment of the assembly of FIG. 1, illustrating that the assembly can accommodate living spaces on multiple levels.

### DESCRIPTION OF ONE EMBODIMENT

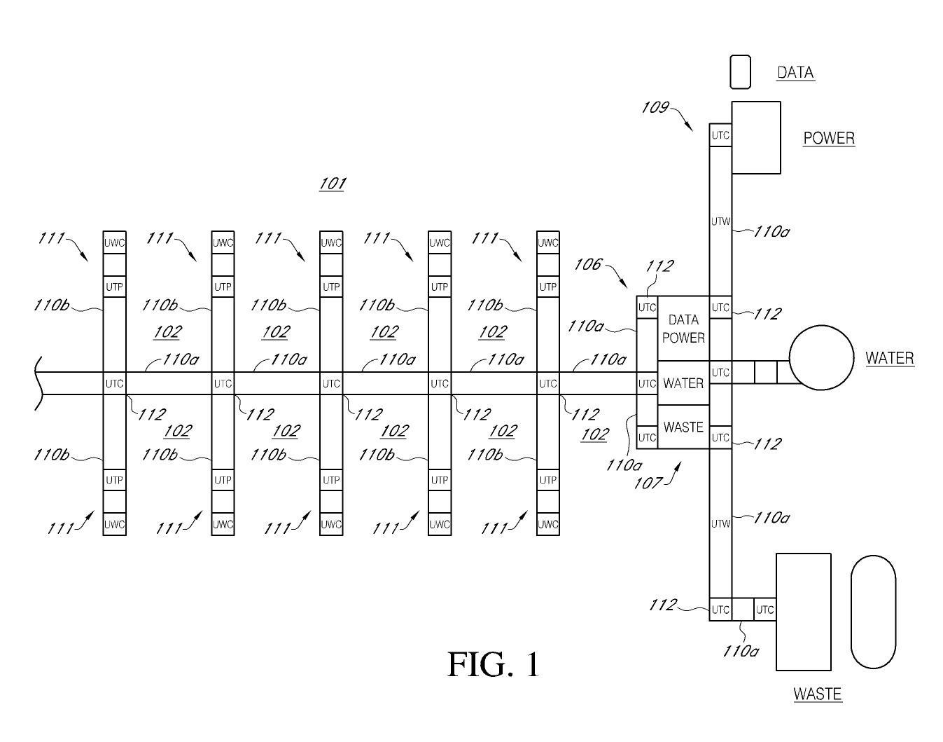

Reference will now be made to the drawings where like numerals refer to like parts throughout. Referring initially to FIG. 1, one embodiment of a living assembly 100 is shown. The living assembly 100 provides utilities to a facility 101 can include temporary emergency housing or work or storage facilities that uses trailers, mobile homes, containers and the like to house individuals or groups of individuals or equipment, goods, utility components etc.

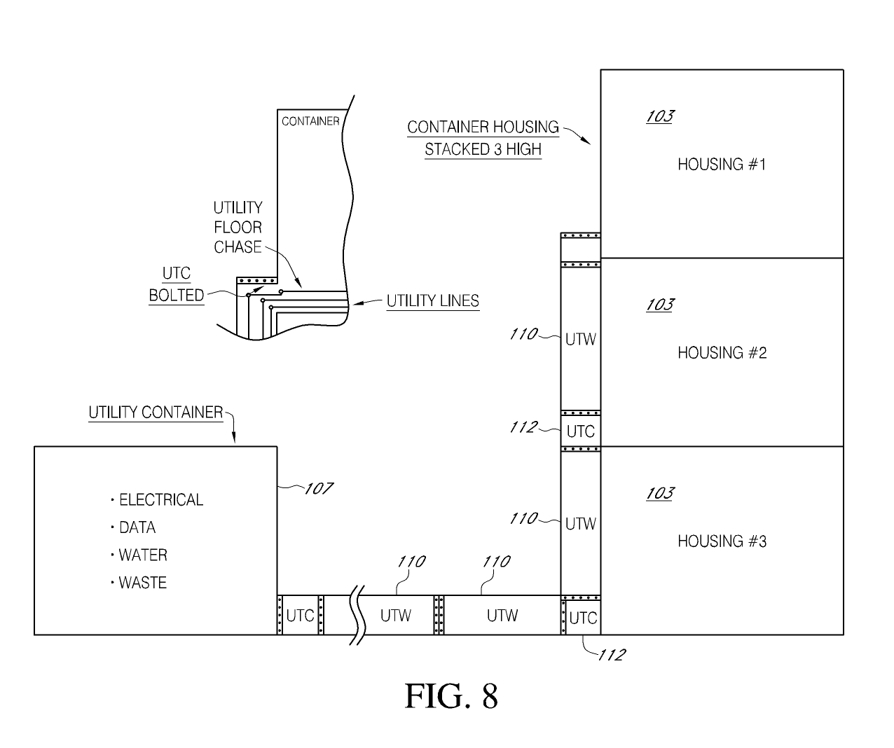

As shown in FIG. 1, the living facility 101 includes a plurality of sites 102 that each accommodate a housing or work unit 103 (FIG. 8). The housing or work unit 108 can include temporary living spaces such as trailers, RVs mobile homes, tents, containers, modular buildings and manufactured homes without limitation and the site 102 is variably sized accordingly. The housing or work unit may also include more utilitarian spaces such as trailers that are configured for offices, workshops and the like. The sites 102 define a geographic space that can accommodate the housing or unit. The housing or work unit, in some implementations, can include more permanent homes, offices, work or storage spaces as the function of the living assembly 100 is to be able to provide utilities, such as power, water and sewage to a plurality of different sites 102 in an efficient and low cost manner.

As is also shown in FIG. 1, the assembly 100 is preferably connected to a main utility supply 106. The main utility supply 106 can include one or more utility supplies such as a water source, a sewer or septic connection, an electrical connection, a cable connection, a communications connection and the like. The main utility supply 106 is shown, for illustrative purposes only, as being located in a single general location, however, persons of ordinary skill in the art will understand that different locations for each of the supply utilities can be provided without departing from the spirit and scope of the present invention. For example, the power, cable and communications utility can be provided via an underground conduit, via an overhead service or some varied combination thereof or the location of each source may be different for each utility being provided to the assembly 100.

As shown in FIG. 1, the utility 106 includes access points 107 such as utility control rooms through which the utility service is provided. The utility service can either be a permanent utility connection or a temporary utility connection depending upon the application. The utility access points are preferably coupled to utility sources 109 such as water sources, power lines etc. in a well-known manner or via components of the system 100 as will be described below.

As shown in FIG. 1, the assembly 100 includes a plurality of main wall units 110a that are coupled directly to the main utility supply 106. The main wall units 110a are then connected to side wall units 110b via junction units 112. As will be discussed in greater detail below, the wall units 110 and the junction units 112 include pre-assembled utility conductors such as water piping, sewer piping, power conductors, communications and cable wiring etc. that allow the utilities of the main utility service 106 to be easily distributed to a plurality of sites 102 by assembly of the wall units 110 and the junction units 112 into the assembly 100.

As shown in FIG. 1, the main wall units 110a can function as trunk lines that provide utility services to a plurality of branch lines and the branch lines can themselves form trunk lines or can form walls of the sites 102. The sites 102 are preferably sized to receive the housing and work units which can then connect to the utilities via the walls 110b in the manner that will be described in greater detail below.

As shown in FIG. 1, the utility 106 includes access points 107 such as utility control rooms through which the utility service is provided. The utility service can either be a permanent utility connection or a temporary utility connection depending upon the application. The utility access points are preferably coupled to utility sources 109 such as water sources, power lines etc. in a well-known manner or via components of the system 100 as will be described below.

As is also shown in FIG. 1, the wall units 110b may be connected to interconnection units 111 such as utility termination pedestals or utility waste connectors. As will be describe in greater detail below, the side wall units 110b are adapted to be connected to modular units provide connection points to housing and work units to supply electrical power, data services, water and sewage waste in a well-known manner such as, without limitation, the manner in which these utilities are provided in trailer and modular home parks.

The advantage of the wall units 110 and the junction units 112 is that these units are modular and can be pre-assembled with utility conduits such that, by assembly of the wall and junction units, a living space 101 can be assembled whereby the utilities are provided to a plurality of different sites 102 arranged in a plurality of different living locations with the utilities being above ground. This reduces the need for expensive trenching and excavating and, as will be apparent from the following description, the walls 110 and junction units 112 can also form physical boundaries that define each site 102 and provide a measure of privacy for each site.

As is also shown in FIG. 1, the wall units 110 and junction units 112 can also be configured to attach to the utility sources 106 and also interconnect the cabinets to the main utility supplies. As will also be appreciated, while it is preferable to have wall units 110 of the same size, these wall units 110 can be adapted to different lengths for different applications and the junction units 110 and services units 111 can also be similarly adjusted.

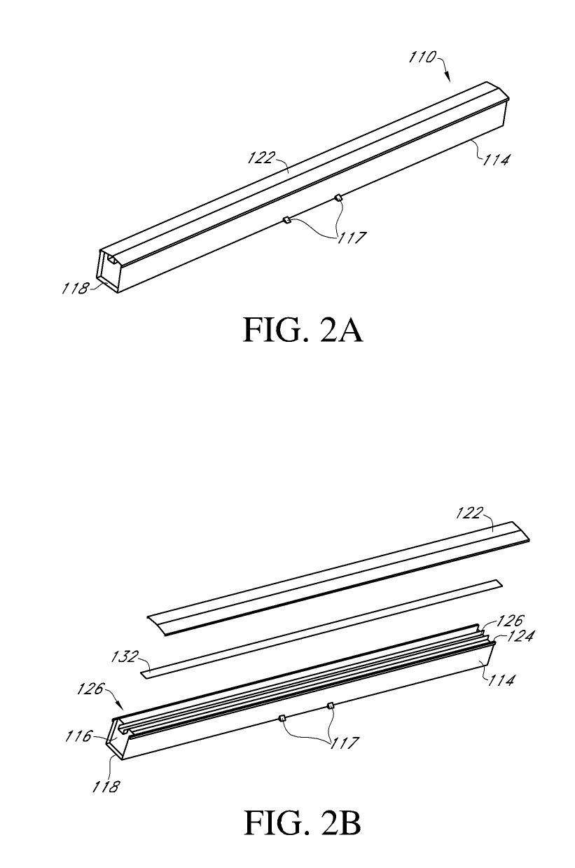

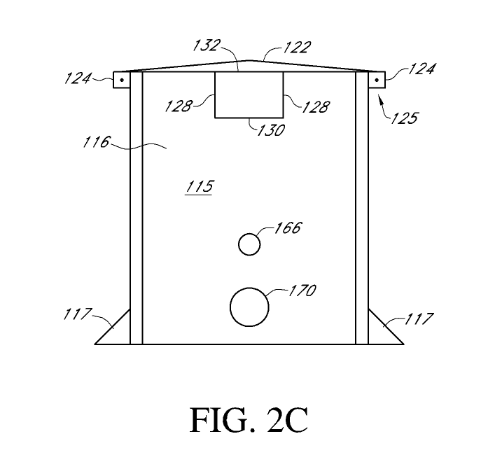

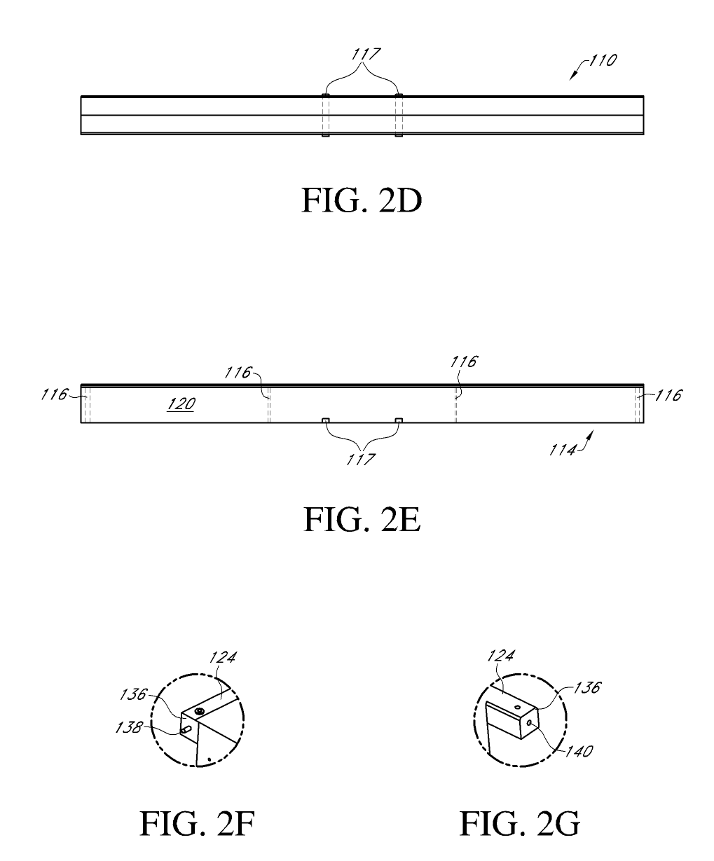

Referring to FIGS. 2A-2E, an exemplary wall unit 110 or utility transfer wall (UTW) is shown. The wall unit 110 can be either a main wall unit 110a or a side wall unit 110b without limitation. As shown, the wall unit 110 comprises an elongate rectangular lower housing 114 that in, one specific non-limiting example is approximately 348 inches long and is 21 inches wide and 24 inches tall. It will be appreciated that these dimensions can, of course, vary depending upon the implementation without departing from the spirit or scope of the present invention. The lower housing 104 preferably is made of sheet metal such as steel, aluminum or the like.

In one specific implementation, the lower housing 114 is comprised of two side walls 115a, 115b that are maintained in a spaced relationship by bottom members 118. The bottom members 118 may be part of one or more bulkhead braces 116 or may be separate. The bottom members 118 may be positioned at the ends of the lower housing 114 or may also be placed at intervals long the lower housing 114 to maintained the spaced relationship. It will also be appreciated that the lower housing 114 can also include a floor member or be exposed to the ground without departing from the spirit or scope of the present invention.

As shown in FIG. 2E, One or more bulkheads braces 116 may also be formed so as to extend along the side walls and bottom walls of the lower housing 104 to reinforce the lower housing 104. In one implementation, the bulkhead braces 116 comprise 1″ by 1″ steel tube with a flat panel extending therebetween that is positioned between the side walls on potentially on the bottom wall of the lower housing 104 to provide additional reinforcement to the wall unit 110. The bulkhead bracing 116 may be placed the ends of the lower housing 114 and may also be placed at mid-section locations as well. It will be appreciated, however, that the wall unit 110 can be reinforced in a variety of manners known in the art without departing from the spirit or scope of the present invention.

As is also shown in FIG. 2D and 2E, the lower housing 114 may also forklift sleeves 117 that extend across the bottom of the lower housing 114 so as to define locations where forklift arms can be inserted to thereby lift and move the wall units 110 for loading and unloading purposes. In one implementation, the forklift sleeves comprise 3″ by 4″ tubing that are located at the mid-section of the wall unit 110. However, it will also be appreciated that the exact location and positioning of the forklift sleeves 117 can also vary without departing from the spirit or scope of the present invention.

The lower housing 114 defines an inner space 120 that can accommodate utility conduits such as water lines, power lines, sewer lines, communication lines, data lines and the like as will be discussed in greater detail below. The lower housing 114 is topped with an upper cover 122 that can be peaked to allow moisture to run off of the upper cover 122. The upper cover 122, in one embodiment has a peak ⅞″ and is formed of sheet metal but this may also vary without departing from the spirit or scope of the present invention. The upper cover 122 can be mounted to a reinforcing member 124 that extends along the length of the lower housing 114 of the wall unit 110 such that the upper cover flanges outward from the inner space 120. In this way, moisture intrusion into the space 120 can be limited. The upper cover 122 is preferably easily removable so that easy access into the interior space and to the utility conduits provided therein may be had to allow for easier interconnection of wall units 110 and junction units 112 and corresponding utility conduits in the manner that will be described in greater detail below. Further, removal of the cover allows for insulation to be positioned in the wall units 110 and the junction units 112 to protect the utility conduits form the elements.

As is shown in FIG. 2C, the upper edge 125 of the lower housing 104 include the reinforcing member 124 that can comprise a 1½″ by 1½″ square tube that extends the length of the lower housing 114. The reinforcing member 124 may provide a surface onto which the cover is attached as described above. As will be further described in reference to FIGS. 2F and 2G below, the reinforcing member 124 may also include an interlock system to assist in the assembly of the living assembly 100.

As is also shown in FIGS. 2B and 2C, an electrical chase member 126 may be suspended in the space 120 at the approximate centerline of the upper cover 122 and extend the length of the wall member 122. The electrical chase member 126 may be held in position by the bulkhead brace 116 in the manner shown in FIG. 2B. The electrical chase member 126 has side walls 128 and a bottom surface 130 and is preferably dimensioned to receive electrical conductors so as provide electrical power from the utility 106 to the sites 102. As will be described in greater detail below, the lower portions of the lower housing 104 are equipped with piping that comprise a conduit for the sewer and water connections from the main utility 106. The electrical chase 126 is preferably suspended above the water conducting utility conduits for safety reasons but a person of ordinary skill in the art can appreciate that the electrical chase 126 can be positioned in a number of locations along the length of the wall unit 110a.

As shown in FIGS. 2B and 2C, the electrical chase 126 further includes a cover 132 that covers the volume that is to receive the electrical conduits. The cover 132 provides additional protection against water intrusion for the conductors. Further, the electrical chase 126 is preferably dimensioned to allow access to other utility conduits located in the space 120 to facilitate interconnection during assembly of the wall units 110 and junction units 112 in the manner that will be described in greater detail below.

As shown in FIGS. 2F and 2G, the ends 136 of the reinforcing members 124 may include mating interconnection members 138 and 140. In one implementation, the mating interconnection member 138 comprises a male alignment pin that extends into an opening that defines the interconnection member 140. In this way, the wall units 110 can be pre-assembled to junction units 112 or to other wall units 110 prior to final interconnection which facilitates the assembly of the assembly 100.

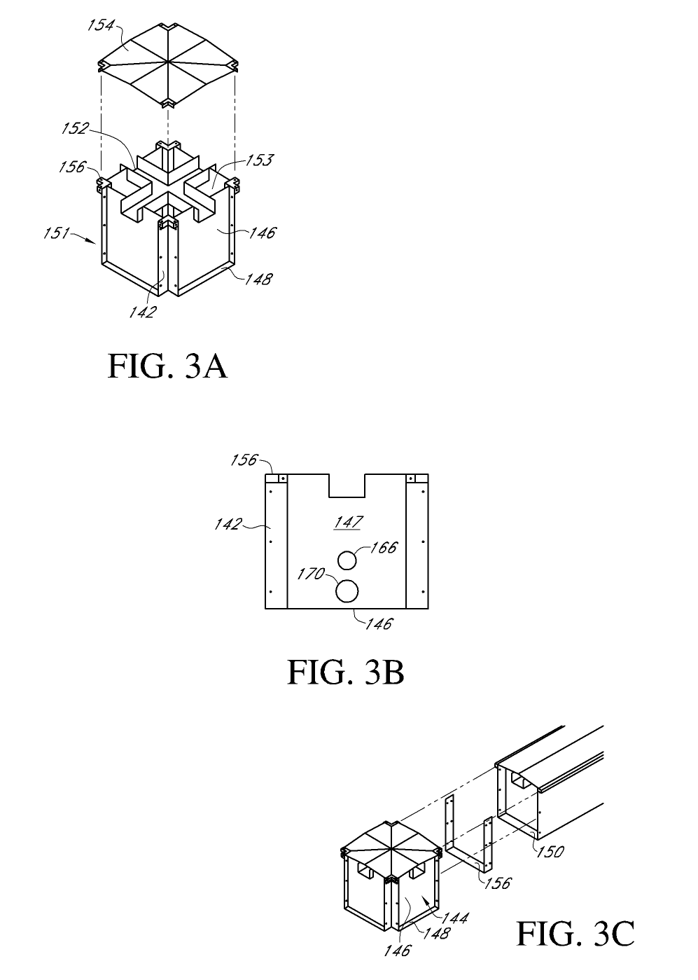

FIGS. 3A and 3B illustrate various components of a junction unit 112 or universal transfer connector (UTC) that interconnect multiple wall units 110. The junction unit 112 can be configured to interconnect from one to four wall units 110. As shown, the junction units 112 each comprise four walls 142 with openings 144 that are sized to match the inner space 120 in the ends of the wall units 110. The four walls 142 define a lower housing 151 that includes an inner space 153 that has similar cross-sectional dimensions as the inner space 120 of the wall units 110. The junction unit openings 144 preferably have bulkhead members 146 define flanges 148 that interconnect with flanges 150 formed by the bulkhead members 116 of the wall units 110 in the manner that will be described in conjunction with FIG. 3C.

As is also shown in FIGS. 3A and 3B, a cross-piece electrical chase member 152 is formed in the upper portion of the junction member 112 so as to mate with the chase member 126 of the wall units 110. The cross-piece electrical chase member 152 allows wiring conductors, such as power lines etc. to be routed into a plurality of different directions from the wall units 110. The cross-piece electrical chase member 152 is, in one implementation, 6″ inches wide by 4″ deep but this can vary without departing from the spirit of the present invention.

As is also shown in FIGS. 3A and 3B, the junction unit 112 preferably also includes a removable cover 154 that is sized so as to fit over the lower housing 151 of the junction member. The cover 154 is preferably peaked also to facilitate water drainage and overhangs the walls 142 of the junction unit 112. In one implementation, the cover 154 is coupled to mounting members 156 formed at the upper corners of the walls 142 where the walls 142 come together. Preferably, the cover 154 is secured to the walls 142 via the mounting members 156 and fasteners so as to be easily removable. The cross-piece chase member 152 is preferably sized so as to facilitate access into the inner space 153 of the lower housing unit 151 to permit interconnection of the utility conduits during assembly of the assembly 100.

As shown in FIG. 2C and FIG. 3B, the bulkheads 116, 146 may define plates 115, 147 that support utility conduits 160 such as the electrical chase 126, water lines 166 and sewage lines 170. As discussed above, with respect to the electrical chase, the junction unit may have a 4 way water line, sewer line or other utility conduit so as to transfer the conduit outward towards any side. Preferably, the utility conduits are formed in the wall units 110 and the junction units so as to be interconnect able in manner that will be described in greater detail below.

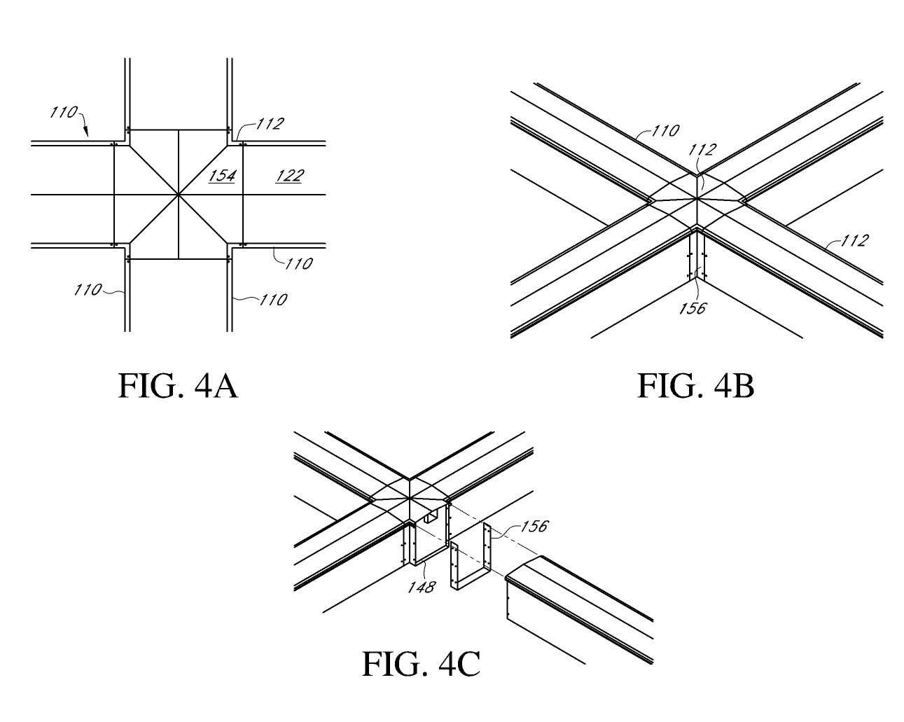

FIG. 3C and FIGS. 4A-4C illustrate how this embodiment of wall units 110 and junction units 112 are interconnected. In this implementation, the flange 148 of the junction unit 112 can be joined to the flange 150 of the wall unit 110 via a u-shaped member 156 that is partially positioned inside of the flange 148 of the junction unit 112 and the flange 150 of the wall unit 110. The flanges can be connected to the u-shaped member 156 when covers 122 and 154 are removed to thereby permit access for an assembler to position fasteners such as nuts, bolts and screws therethrough.

As is shown in FIGS. 4A-4C, wall units 110 can be joined on four sides of the junction unit 112. It will be appreciated that covers can be positioned on one or more sides of the junction units 112 with wall units 110 being connected on a single side. Similarly, wall units 110 may also be interconnected to each other using the u-shaped member 156 or similar connection devices.

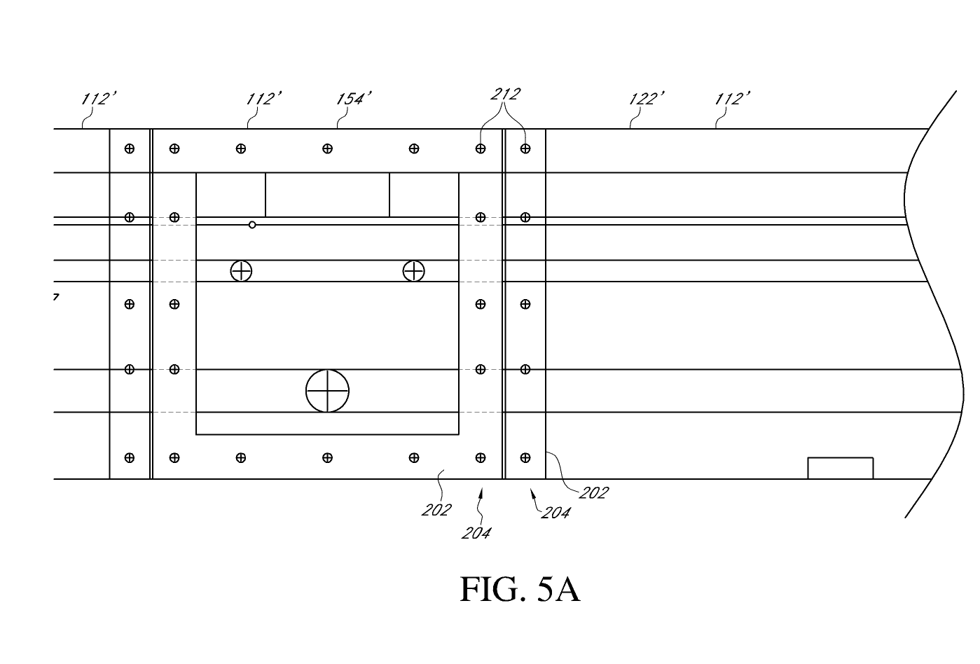

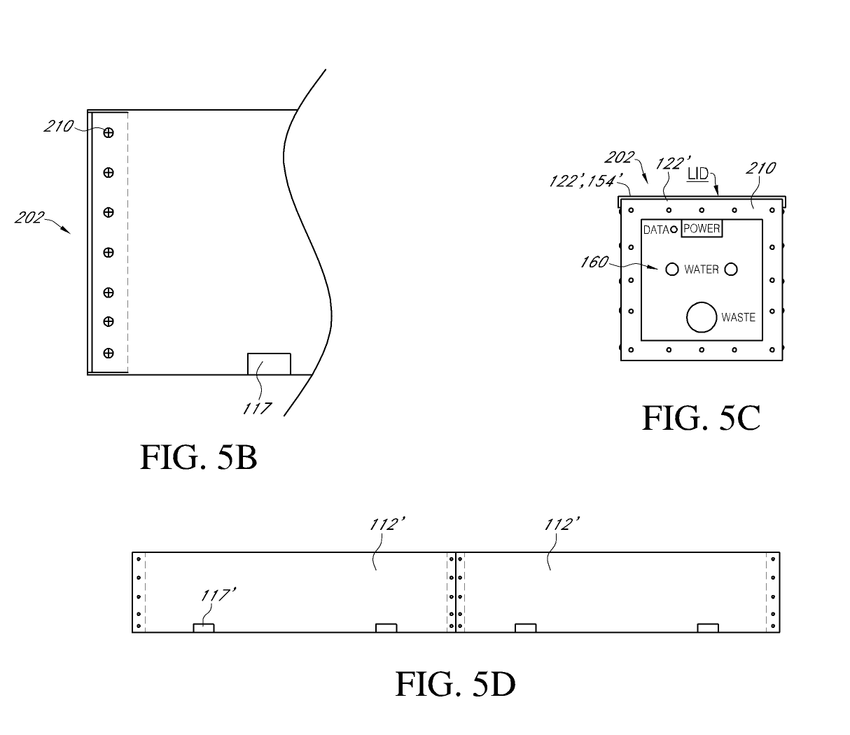

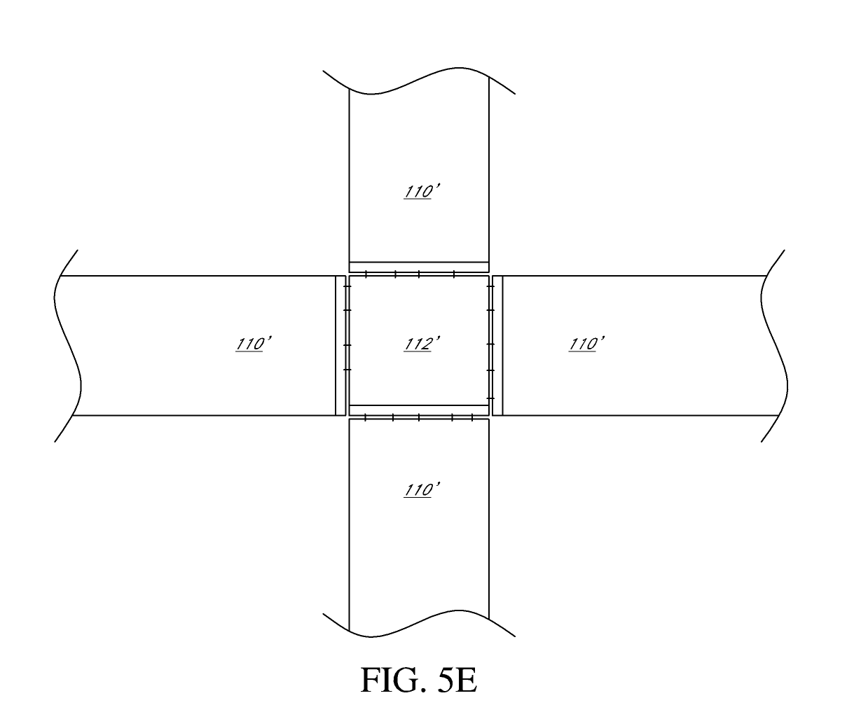

FIGS. 5A-5E illustrate another configuration of wall units 110′ and junction units 112′ that are joined together slightly differently. In this configuration, the wall units 110′ and the junction units 112′ have flat flanged surfaces 202 at their respective ends 204 and 206. These flat flanged surfaces 202 abut with each other and fasteners can extend through the surfaces to secure the wall units 110′ to the junction units 112′. It will be appreciated that an interface or interconnection unit 111 can also be similarly configured as the wall units 110′ and the junction units 112′ and can be interconnected in the manner described herein. The flanged surfaces include flanges 210 that extend inward into the plane of the openings into the inner spaces 120′ and 144′ of the wall units 110′ and junction units 112′ in the manner shown in FIG. 5C. Fasteners, such as nuts and bolts can then be extended through the flanges 210 to secure the units together.

Further, as shown in FIG. 5D, the flat flanged surfaces 202 on the wall units 112′ can also be positioned and attached to each other. The wall units 110′ and junction units 112′ also contain the same utility conduits 160′ and also have covers 122′ and 154′ that can be removed to permit access to interconnect the units and also to interconnect the conduits. The covers 122′ and 154′ can either be flat or peaked in the same manner as described previously.

The flat flange interface facilitates and simplifies interconnection between wall units 110′, junction units 112′ and some combination thereof. As this embodiment does not have bulkhead plates that support the conduits 160′, it may be necessary to attach the conduits 160′to the side walls and upper surfaces of the wall units 110′ and junction units 112′ using well known pipe, conduit and cable hangers. As is also shown in FIGS. 5A-5D, the flat flanged surfaces 202 can be bolted to the ends 204 of the wall units 110′ and the junction units 112′ via fasteners 212 in the manner shown.

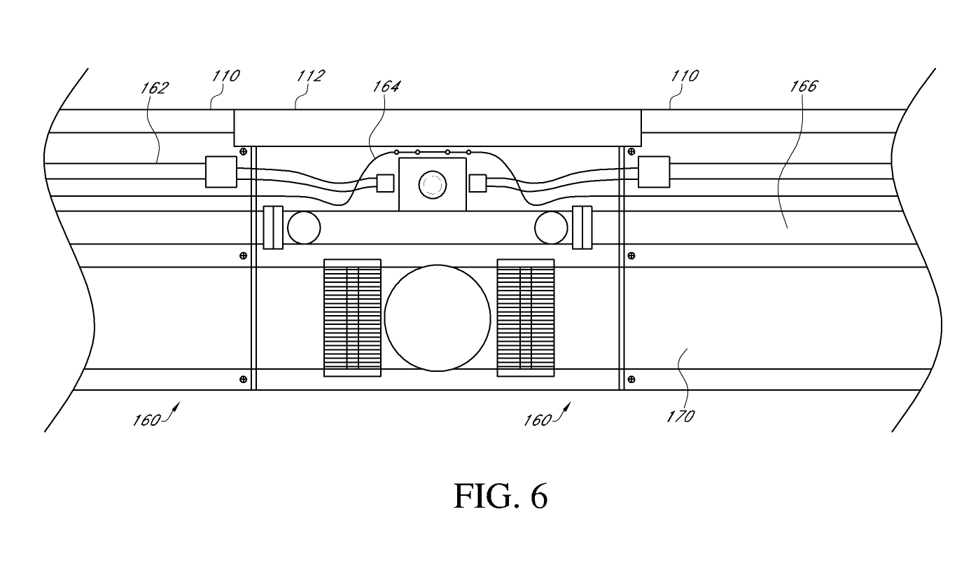

FIG. 6 is a cross-sectional view of one embodiment of the wall units 110, 110′ or junction units 112, 112′ that illustrate how the utility conduits are positioned within the wall units 110, 110′. As discussed above, the utility conduits in the embodiment of FIGS. 2A-2E are suspended via the bulkheads 116 and 146 in the wall unit 110 and the junction unit 112. In the embodiment of FIGS. 5A-5E, the utility conduits are connected to the walls via known hangers and the like as the wall unit and junction units 110′ and 112′ do not have bulkheads.

As shown in FIG. 6, in either embodiment, a plurality of utility conduits 160 extend outward from the ends of the wall units 110, 110′ such that they extend into the junction units 112, 112′. The utility conduits can include electrical conduits 162 such as the electrical chase 126 or can be standard conduit or electrical cables. The utility conduits 160 can also include communications cables 164. Further, the utility conduits can include water lines 166 and sewage lines 170. Each of the conduits 160 is connected to a corresponding conduit in the junction unit 112. The conduits in the junction unit 112 are preferably 4 way junction units such that the conduits 160 can be interconnected so as to extend in 4 directions from the junction unit 112. The conduits 160 in the junction unit 112 can also have valves or caps so as to close off one or more of the four legs of the conduit on a side of the junction unit 112 that is not connected to a wall unit 110 or other device. The connectors for the water lines 166 and sewer lines 170 can be standard pipe fittings. As the cover is removable from the junction units 112, and the wall units 110, interconnection of the conduits 160 in the wall units 110 and the junction units 112 is simplified for the installer.

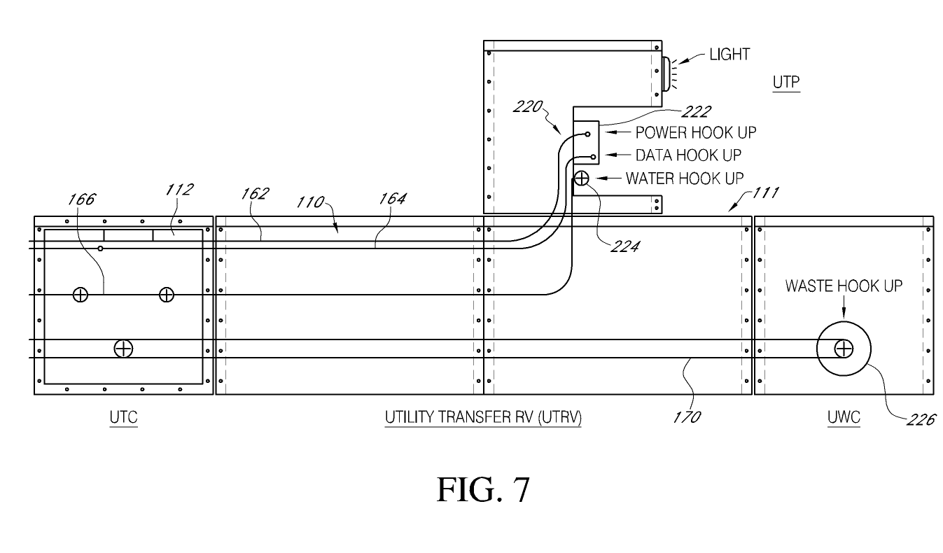

FIG. 7 is an example of a wall transfer or interconnection unit 111 such as an RV utility transfer unit (UTRV) that is adapted to have service outlets 220 that permit interconnection of the assembly 100 to the living or work units in the spaces 102. As shown, there is an electrical and data outlet 222 positioned on the upper cover of the work unit 110 that connects to the electrical and communications conduits 162, 164. Further, there is a water outlet 224 and a sewer outlet 226 that couple with the water and sewage conduits 166, 170 of the wall units and the junction units. These outlets can be similar to the outlets that are commonly used in trailer park applications. The exact placement of these units can vary depending upon the implementation without departing from the spirit and scope of the present invention. As shown in FIG. 7, a pedestal 230 such as a utility transfer pedestal (UTP) may be formed to house the interconnections for the power, data and water. This pedestal 230 may be formed to sit on top of a wall unit 110 to form a transfer unit 111 or may be part of a dedicated transfer unit 111. The exact placement of the interconnections can vary without departing from the spirit or scope of the present invention. Further, as shown in FIG. 7, a utility waste connection unit (UWC) may also be formed adjacent ground level to facilitate the waste hook up 226. In one implementation, the waste hook up 226 may include a vacuum assisted component to extract the sewage out of the unit that is connected to the waste hook up 226 as the waste hook up 226 may be located above the level of the sewage storage tank in the unit.

FIG. 8 is a schematic illustration that illustrates wall units 110 and junction units 112 can be modified to replace the cover 154 with a vertically extending wall unit 110 such that a raised living or work unit 103, such as a side positioned on a trailer or raised platform or a set of stacked containers, can also be accommodated by the living assembly 100. In this case, the conduits within the junction units 112 would also have to include bended conduit elements to accommodate this feature.

While the foregoing discussion has shown, illustrated and described at least one embodiment of the present invention, various changes to the form, implementation and use of the invention may be made by those skilled in the art without departing from the spirit or scope of the present invention. Hence, the scope of the present invention should not be limited to the foregoing discussion but should be defined by the appended claims.

What is claimed is:

1. An assembly for providing utilities to a plurality of living spaces, the assembly comprising:
a plurality of pre-assembled wall units that define an interior space that include a plurality utility conduits positioned within the interior space;
a plurality of junction pre-assembled junction units that define an interior space, that include a plurality of utility conduits wherein the plurality of pre-assembled wall units and the plurality of pre-assembled junction units are assembled so as to define a plurality of living spaces sized to accommodate a work unit or housing unit; and
a plurality of transfer units that are coupled to the utility conduits of the plurality of wall units so as to provide outlets and inlets for the housing and work units to couple to the utilities provided by the plurality of wall units and junction units.

2. The assembly of claim 1, wherein the plurality of utility conduits include electrical power, communications cabling, water and sewage.

3. The assembly of claim 1, wherein the plurality of pre-assembled wall and junction units include removable covers that permit access to the utility conduits so that the utility conduits can be interconnected with each other.

4. The assembly of claim 1, wherein the plurality of utility conduits in the plurality of wall units extend outward of the ends of the wall units such that the interconnection between the plurality of utility conduits in the wall units and the junction units occurs within the interior space of the junction units.

5. The assembly of claim 1, wherein the ends of the plurality of wall units and junction units include flanges and the flanges are interconnected via a u-shaped connection member.

6. The assembly of claim 5, wherein the plurality of wall units and the plurality of junction units define bulkheads adjacent the flanges and wherein the bulkheads support and maintain the plurality of conduits in a fixed relationship with respect to each other.

7. The assembly of claim 1, wherein the plurality of wall units and the plurality of junction units include end surfaces that are positioned flush to each other such that the plurality of junction units and wall units are interconnected via fasteners through the flush surfaces.

8. The assembly of claim 1, wherein the plurality of junction units are four sided and are configured to be coupled to four separate wall units.

9. The assembly of claim 8, wherein at least some of the sides of at least some of the plurality of junction units have covers so as to seal off the sides of the junction units.

10. The assembly of claim 1, wherein the plurality of wall units include wall units that are interconnected to each other.

11. The assembly of claim 1, wherein the junction unit is adapted to connect to a vertically extending wall unit that is adapted to be connected to a living or work unit positioned on a second vertical level.

12. The assembly of claim 1, wherein the transfer assembly includes a sewage system that is equipped with a vacuum to facilitate removal of sewage from one or more living or work units.

13. A living or work facility, the facility comprising:
a plurality of sites that are sized to receive a plurality of living or work units that can accommodate individuals and have water fixtures and power fixtures;
a plurality of wall units that are sized so as to be positioned above ground, wherein the plurality of wall units have utility conduits formed therein that are adapted to be connected to a utility sources;
a plurality of junction units that interconnect the wall units and have utility conduits formed therein so as to facilitate interconnection of the utilities in the wall units with different wall units; and
a plurality of transfer units that interconnect the utilities to the living or work units on the plurality of sites.

14. The facility of claim 13, wherein the plurality of utility conduits include electrical power, communications cabling, water and sewage.

15. The facility of claim 13, wherein the plurality of pre-assembled wall and junction units include removable covers that permit access to the utility conduits so that the utility conduits can be interconnected with each other.

16. The facility of claim 13, wherein the plurality of utility conduits in the plurality of wall units extend outward of the ends of the wall units such that the interconnection between the plurality of utility conduits in the wall units and the junction units occurs within the interior space of the junction units.

17. The facility of claim 13, wherein the plurality of junction units are four sided and are configured to be coupled to four separate wall units.

18. The facility of claim 13, wherein the junction unit is adapted to connect to a vertically extending wall unit that is adapted to be connected to a living or work unit positioned on a second vertical level.

19. A method of creating a housing or work facility at a location having utility service, the method comprising:
assembling a plurality of wall units and junction units, each pre-assembled with utility conductors so that the wall units and junction units are above ground and define the boundaries of sites that are to receive a work or living unit;
interconnecting the pre-assembled utility conductors in the wall units and junction units so that the utility service provided to the location is distributed via the wall and junction units;
connecting transfer units to the assembled wall units and junction units, wherein the transfer units include utility transfer components that allow the work or living unit to connect to the transfer unit and thereby be connected to the utility service.

20. The method of claim 19, wherein the plurality of wall and junction units are pre-assembled with water, power, sewage and data conductors.

21. The method of claim 19, wherein the wall units and elongate units and the junction units are square units that can accommodate up to four wall units positionable at right angles to each other and wherein the junction units include 4 way utility conduits so that the utilities can be extended in each of the four directions.

22. The method of claim 19, wherein the wall units and junction units have flanges that are positioned flush to each other such that connectors extending between the flanges interconnect the wall and junction units.

23. The method of claim 19, wherein the wall units and junction units are connected via a connector that extends between the wall and junction units.
